(19) United States
(12) Patent Application Publication
(10) Pub. No.: US 2025/0385784 A1
(43) Pub. Date: Dec. 18, 2025

(54) METHOD FOR MANAGING A GROUP SHARING A SECRET KEY

(71) Applicant: COMMISSARIAT A L'ENERGIE ATOMIQUE ET AUX ENERGIES ALTERNATIVES, Paris (FR)

(72) Inventors: Dylan PAULIN, Grenoble Cedex 09 (FR); Christine HENNEBERT, Grenoble Cedex 09 (FR); Quentin JAYET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/234,534

(22) Filed: Jun. 11, 2025

(30) Foreign Application Priority Data
Jun. 12, 2024 (FR) FR2406249

(51) Int. Cl. H04L 9/08

(52) U.S. Cl. CPC H04L 9/0825; H04L 9/085

(57) ABSTRACT

The invention relates to a method for managing a group comprising a plurality of members (U₁ . . . Uₙ), each member (Uᵢ) holding or being capable of holding a group secret key (SKj,k,p).

The method uses an asymmetric cryptosystem and a registry (B) wherein a smart contract (SC) is deployed.

A data structure such as a binary tree or a chained list (A) is used to organize the group members.

The method comprises a procedure for adding a member to the group to include a candidate seeking to join the group, during which, by means of operations similar to the Diffie-Hellman protocol and using the smart contract, the new member is added to the group, and a new group secret key is computed and shared by each of the group members including the new member.

### TECHNICAL FIELD OF THE INVENTION

The field of the invention is the secure execution of operations by one or more members of a group. These operations include exchanging messages between group members, controlling access to sensitive zones (using a unique identifier), etc.

To ensure that such operations are carried out securely, in a manner known per se, a group secret, which can also be referred to as a secret key, can be shared by the group members.

Consequently, the invention more specifically relates to a method for managing a group allowing the sharing of a group secret within the group.

### PRIOR ART

The communication of information between parties, for example by means of an instant messaging application, requires the consideration of a number of constraints.

Such an application may need to provide a guarantee of confidentiality within each group, and protect the identification data of members, in order to meet the various applicable regulations, such as the General Data Protection Regulation in the European Union.

Producing such an application is particularly complex in a context where members communicate via their personal devices, for example smartphones, forming a decentralized asynchronous communication network.

To produce such an application with a high communication security level, a known solution consists of managing each group of members needing to exchange messages securely in such a way that a common secret is shared between the group members.

This common secret will then be used (in particular) to compute an encryption key, for example symmetric, to allow the exchange of information between the group members in a secure manner.

However, maintaining a common and unique secret for each group allowing its members to exchange encrypted messages known to them alone, in such a way that this secret is updated each time a member leaves or joins the group, while ensuring the continuity of confidential exchanges for the other group members, requires providing several properties:
Continuity of updates of the group encryption key when a new member joins,
Updates of the group encryption key when a member leaves,
Continuous access to the group encryption key for all group members.

Security requirements may be added, in particular:
That secrets be computed and stored on each user device authorized to know them,
Preventing single points of failure in the system, where an attack could compromise the availability and/or confidentiality of the solution,
Preventing man-in-the-middle attacks while preserving members' identification data.

To allow a common cryptographic secret to be shared between the members of a group, it is necessary to encrypt data in order to exchange it confidentially within the group. This requires a means for sharing public intermediate information allowing private computation of the common secret. If the group members' communication devices are connected within the same network, they can exchange messages allowing the creation of the common secret. For example, public information (such as public keys) can be transmitted via the Internet if the IP addresses of each group member are known to all the other members.

In most existing messaging applications, a server is used to exchange public information within a group.

However, such a centralized server is a potential single point of failure, particularly exposed to the consequences of various cyberattacks such as denial-of-service attacks, man-in-the-middle attacks, malware attacks, etc.

To avoid such vulnerability, an alternative solution is to use blockchain to allow information sharing between two parties. Such communication methods are disclosed for example by French patent applications no. 1763393 and no. 1763394.

The methods disclosed by these patents use the Diffie-Hellman protocol for exchanging information between two actors. This protocol is a procedure allowing the generation of a shared secret between two parties, known only to these two parties.

The generation of such a session key is based on the holding of an asymmetric key pair by each of the two parties involved in the Diffie-Hellman protocol. Thus, by implementing this protocol, one party having an asymmetric key pair that is specific to them is able to initiate the computation of a secret shared with another party also having an asymmetric key pair that is specific to them.

For the implementation of this Diffie-Hellman protocol, each of the two parties must have an asymmetric key pair, comprising a private key and the corresponding public key (this asymmetric key pair is therefore computed by means of an asymmetric cryptosystem).

The asymmetric cryptographic algorithm used is generally a modular arithmetic algorithm: The cryptosystem can be a Rivest-Shamir-Adleman (RSA), or Elliptic Curve Cryptography (ECC) cryptosystem.

The Diffie-Hellman protocol includes the following steps:
A1) each of the two parties registers the public key of their asymmetric key pair in the registry;
A2) each of the two parties reads the other's public key in the registry; and
A3) each of the two parties constructs the shared secret.

The Diffie-Hellman protocol thus makes it possible to generate a shared secret between two parties. It is described in more detail in French patent applications no. 1763393 and no. 1763394 cited above.

However, the communication methods are limited to the exchange between two parties.

Other methods have been developed based on the Diffie-Hellman protocol to allow the secure exchange of information within a group of more than two parties. Among these methods, the best-known use annular and tree representations of the group.

In these latter methods, the generation of a secret shared by the group requires several successive executions of the Diffie-Hellman protocol. The main difference between these different methods is the organization and order of execution of these protocols.

However, these latter processes do not provide a sufficient level of security against man-in-the-middle attacks.

There is therefore a need for communication methods allowing the exchange of information in a secure manner between members of a group, these methods being robust against man-in-the-middle attacks, and not requiring the use of a central server.

### DISCLOSURE OF THE INVENTION

The present invention aims to overcome all or some of the aforementioned drawbacks of the prior art.

To allow the creation of messaging applications between members of a group, or more generally applications allowing the exchange of information between members of a group, according to the present disclosure, a method for managing a group allowing the sharing of a group secret (more specifically a group secret key) within the group, also called ‘management method’, is proposed.

Indeed, advantageously, holding a common group secret key within a group makes it possible to determine an encryption key, for example symmetric: this then allows the exchange of information in a secure manner between the group members.

According to a first aspect of the invention, a first method for managing a group is proposed, wherein the group is tracked using a binary tree.

The method is a method for managing a group comprising a plurality of members, each member holding or being capable of holding a group secret key, the method using an asymmetric cryptosystem (Enc,Dec) verifying the property, for two asymmetric key pairs (PK1,SK1) and (PK2,SK2):
Enc(PK1,SK2)=Enc(SK1,PK2), where Enc is the encryption function of the cryptosystem, and a registry wherein a smart contract is deployed;
a binary tree being used to organize the group members;
each member being associated with a terminal node of the tree, this node being attached to a root node of the tree, directly or via a sequence of at least one node, the root node and when it exists said sequence of at least one node forming the attachment chain of the considered member;
each group member having an asymmetric key pair, of which the secret key and the public key are considered as the node secret key and the node public key for the terminal node associated with the member;
the public key of the root node being referred to as group public key;
the method comprising a procedure for adding a member to include a candidate seeking to join the group in the group, at a given time when
the group is formed by a set of members, referred to as pre-addition members, forming a pre-addition tree,
each pre-addition member has or is capable of computing a pre-addition node secret key for any node of their attachment chain; and
for each node of the pre-addition tree, a pre-addition node public key is registered in the registry;
the procedure for adding a member comprising the following operations:
S10) a request for entry of the candidate into the group is sent to the smart contract, the request for entry comprising an authenticator and a personal public key of the candidate, the candidate further holding a personal private key from which their personal public key has been computed by means of the cryptosystem;
S20) the smart contract registers in the registry the entry into the group of a new member having the candidate's authenticator and the candidate's public key;
S30) the candidate determines or obtains from the smart contract a list of the node(s) of their attachment chain in the tree;
S40) in a neighbor-to-neighbor manner (or step by step), for each node of their attachment chain, from the node of the tree to which they are directly attached to the root node (N1), the candidate computes the node secret key followed by the node public key;
S50) the candidate publishes in the registry the node public key(s) computed in step S40;
S60) the smart contract sends a member addition message at least to each active pre-addition group member; and
S70) on receipt of the member addition message, in a neighbor-to-neighbor manner (or step by step), for each node of their attachment chain that is also part of the candidate's attachment chain, in the direction from the node of the tree to which they are directly attached to the root node, each active pre-addition member computes the node secret key;
the node secret key of a given node being computed by a party (or a member) whose attachment chain contains a first child of the given node:
   if said given node has a second child and said party has access to a non-compromised public key of the second child, according to the secret key of the first active child and the public key of said second child of said given node; or in any other case,
   according to the secret key of the first child of said given node.

The method defined above can be implemented with different cryptosystems, on the condition that they verify the property stated above (Enc(PK1,SK2)=Enc(SK1,PK2)). It is thus possible to choose an elliptic curve cryptosystem, an RSA cryptosystem, or optionally certain post-quantum cryptosystems in particular lattice-based.

For the implementation of the method, a rule for adding new members to the tree (also called a tree construction rule) is furthermore chosen in advance.

Depending on the rule chosen, the position in the tree at which a new group member is added can either be computed simply based on the information of the successive arrivals and departures of group members, or result from a choice. In the first case, in step S30, the candidate can determine their attachment chain themselves. This is the case, for example, if during the construction of the tree, on one hand, if a member leaves, no new member takes their position; and if the candidates are positioned in the tree in such a way that all the group members, at all times, are positioned at the same level in the tree, and positioned at that level in chronological order of the last entry into the group. In the second case, the position in the tree assigned to a new member can be determined by the smart contract; the latter then communicates their attachment chain to the candidate, following their entry in step S30.

In step S10, depending on the case, the request for entry of the candidate into the group can be sent to the smart contract either directly by the candidate (the group is then referred to as an ‘open group’), or by a party responsible for verifying that it is appropriate for the candidate to join the group, for example a group administrator.

Advantageously, following the member addition operation, each of the group members—i.e. both the pre-addition members and the new member (candidate)—has or is capable of computing the node secret key for any node of their attachment chain.

The group members are authenticated in the registry by their account address which is an authenticator, annotated accUser. This authenticator is used continuously to identify the member during interactions with the smart contract.

Thus, thanks in particular to the use of the smart contract, the method proposed above makes it possible to form a group sharing a group secret key with a high degree of security, only public information (public keys) being sent to form the group secret key. In particular, the proposed method advantageously does not require the use of a central server.

In the present document, the following definitions and conventions are used.

A registry, also known as a ‘ledger’, means a structure wherein data is saved securely, in the field of ‘Distributed Ledger Technology’. A registry is generally distributed. A registry can be open (or ‘permissionless’), i.e. anyone can view the data saved in the registry. A typical example of a registry is a blockchain, such as Bitcoin or Ethereum.

A smart contract is a code intended to interact with a registry, and registered therein at an address specific to the smart contract. At the time of mining, the validator nodes execute the smart contract; if there is a consensus on the result, it is registered in the registry.

The expressions ‘a new key is computed’ or ‘a new value for the key is computed’ have the same meaning and can be used interchangeably.

Blockchain has the advantage of being decentralized and has no single point of failure. In addition, blockchain is robust against most denial-of-service attacks thanks to the use of gas, against man-in-the-middle attacks thanks to the use of account addresses as authenticators, and against malware by making the content of the registry transparent and viewable by all actors.

Thus advantageously, the method according to the present disclosure meets the protocol requirements (update, upgrade, continuous access) through a high-performance, effective and secure method.

Furthermore, the method according to the present disclosure also takes into account the security and protection requirements in respect of personal data and identifying data of members, through an innovative decentralized architecture based on the smart contract executed on a blockchain.

Naturally, an asymmetric cryptographic system is defined on a commutative field.

In some implementations, the method further comprises a procedure for removing a member from the group, referred to as departing member (Up), other than the member who last joined the group, to remove the departing member from the group, said procedure for removing a member comprising:
S100) a request to remove the departing member is sent to the smart contract;
S110) the smart contract sends a key update message at least to each remaining active group member, indicating as key(s) to be refreshed and as compromised key the secret key of each of said node(s) of the attachment chain of the departing member;
S120) each remaining active member, referred to as considered remaining member (U2), evaluates the node, referred to as first common node, which is the node of their attachment chain furthest from the root node and which also belongs to the key chain to be refreshed;
S120-1) if the public key of the first common node has been refreshed since the key update message, in a neighbor-to-neighbor manner (or step by step), the considered remaining member computes the secret key and the public node key of the considered node, from the first common node to the root node; conversely,
S120-2) if the public key of the first common node has not been refreshed since the key update message:
   S120-22) for each node, referred to as node to be updated, located on the attachment chain from the first common node to the root node, the considered remaining member computes the secret key and the public node key of the node to be updated, and publishes the latter in the registry, said node to be updated then being referred to as updated node; any node for which the public key is compromised being considered as non-existent during any node secret computation;
   S120-24) the smart contract sends a node update message at least to each other active group member, i.e. at least to each active group member, other than the departing member and the considered remaining member, indicating the updated node;
   S120-26) in a neighbor-to-neighbor manner (or step by step), each other member computes the node secret of the considered node, for each updated node also belonging to their attachment chain, in the direction from the terminal node of the tree to which they are attached to the root node.

Thus, each remaining active group member has, or at least is capable of computing, a group secret key for all the nodes of their attachment chain. Advantageously, the new group secret key(s) recomputed as part of this removal procedure are not accessible to the departing member.

For members who are inactive when the member removal procedure is executed, the following procedure can be provided.

In an alternative embodiment described above, the method for managing a group further comprises a method for reconnecting a group member after removing a departing member, wherein:
S200) when a group member, referred to as reconnecting member, activates their connection to the group after a period of inactivity, the reconnecting member consults the messages received from the smart contract;
S210) when the reconnecting member has received a member removal message from the smart contract, the reconnecting member evaluates the node, referred to as first common node, which is the node of their attachment chain furthest from the root node and which also belongs to the key chain to be refreshed:
S210-1) if the public key of the evaluated node has been published or refreshed since the key update message, in a neighbor-to-neighbor manner (or step by step), the reconnecting member computes the secret key and the public node key of the considered node, from the first common node to the root node; or conversely,
S210-2) if the public key of the evaluated node has not been published or refreshed since the member removal message:
   S210-22) for each node, referred to as node to be updated, located on the attachment chain from the first common node to the root node, the reconnecting member computes the secret key and the public node key of the node to be updated and publishes the latter in the registry, said node to be updated being then referred to as updated node; any node for which the public key is compromised being considered as non-existent during any node secret computation;
   S210-24) the smart contract sends a node update message at least to each other active group member, i.e. each active group member, other than the departing member and the reconnecting member, indicating the updated node;
   S210-26) in a neighbor-to-neighbor manner (or step by step), each other member computes the node secret key of the considered node, for each updated node also belonging to their attachment chain (of the attachment chain of the reconnecting member), in the direction from the terminal node of the tree to which they are directly attached to the root node (Ns).

Different computing modes can be used to compute new node secret keys by implementing the Diffie-Helman protocol.

In some implementations, at least one node secret key of a given node is computed:
by computing a cryptographic element referred to as node shared secret according to the secret key of a first child and the public key of a second child of the given node; and
by computing the secret key of the given node from said node shared secret, for example as being equal to a part of the node secret.

Thanks to the first step above, the method according to the present disclosure more generally allows the computing of a group shared secret, i.e. in this case the node shared secret of the root node. The procedures described in the present disclosure allow group members to maintain, over time, a shared group secret, which is recomputed in particular according to departures and additions of members.

Hereinafter for simplicity, the ‘node shared secret’ is referred to in some cases more simply as ‘node secret’.

In the first aspect of the invention presented above, the group is tracked using a binary tree. The binary tree makes it possible to track the group members relatively simply, and in particular to limit the number of key recomputations required when removing a member.

An alternative solution of the invention will now be described.

According to a second aspect of the invention, a second method for managing a group is proposed, wherein the group is tracked using a chained list. Compared to binary tree tracking, this tracking mode advantageously simplifies the implementation of the method for managing a group. Conversely, advantageously, managing the group members using a binary tree according to the first aspect of the invention, compared to managing the members according to its second aspect, makes it possible to reduce the amount of gas consumed by sending transactions to the blockchain for group management (and therefore the cost of management).

The second method like the first method combines the use of a smart contract and the sharing of keys by Diffie-Hellman protocol to allow the sharing of a shared secret within a group.

The second method is a method for managing a group comprising a plurality of members, each member holding or being capable of holding a group secret key, the method using an asymmetric cryptosystem (Enc,Dec) verifying the property, for two asymmetric key pairs (PK1,SK1) and (PK2,SK2):
Enc(PK1,SK2)=Enc(SK1,PK2), where Enc is the encryption function of the cryptosystem, and a registry wherein a smart contract is deployed;
a list being used to organize the group members;
the method comprising a procedure for adding a member to include a candidate seeking to join the group in the group, at a given time when
the group is formed by a set of members, referred to as pre-addition members,
each pre-addition member has or is capable of computing a pre-addition node secret key of the pre-addition group; and
a pre-addition public key of the pre-addition group is registered in the registry; wherein the procedure for adding a member comprises the following operations:
S310) a request for entry of the candidate into the group is sent to the smart contract, the request for entry comprising an authenticator and a personal public key of the candidate, the candidate further holding a personal private key from which their personal public key has been computed by means of the cryptosystem;
S320) the smart contract registers in the registry the entry into the group of a new group member having the candidate's authenticator and the candidate's public key;
S330) based on the pre-addition public key of the pre-addition group and their personal private key, the candidate computes a new group secret key value followed by a new group public key value for the group;
S340) the candidate publishes in the registry the new public key value of the group (PKgroup n+1) computed in step S330;
S350) the smart contract sends a group key update message at least to each active pre-addition group member; and
S360) on receipt of the group key update message, based on the pre-addition secret key of the pre-addition group and the candidate's personal public key, each active pre-addition member computes the new group secret key value.

By construction, the list of group members is organized in chronological order of their entry dates or instead their last entry dates into the group.

Positions or indexes in the group of group members can be indexed by an index tracked by the smart contract.

In some implementations of the method for managing a group, at the latest shortly after a reconnection of a group member who has been inactive, or at the request of the latter when the latter reconnects, when the member addition procedure has been executed, the smart contract sends a group key update message after adding a member to said member who has been inactive; and the method for managing a group further comprises a method for reconnecting said member who has been inactive after adding a member, wherein:
S400) when said member who has been inactive reconnects to the group, they consult the messages received from the smart contract;
S410) when the reconnecting member has received a group key update message from the smart contract after addition of a member, based on the pre-addition secret key of the pre-addition group and the candidate's personal public key, said member who has been inactive computes the new group secret key value.

In some implementations, the method further comprising a procedure for removing a member from the group, referred to as departing member, other than the member who last joined the group, to remove the departing member from the group, said procedure for removing a member comprising:
S500) a request to remove the departing member is sent to the smart contract;
S510) the smart contract identifies a member, referred to as initialization member, who is an active group member who joined the group before the departing member;
S520) the smart contract sends a new group addition message to each active group member who joined the group after the initialization member, referred to as member to be reintegrated, with the exception of the departing member, inviting the latter to rejoin the group;
S530) on receipt of the new group addition message, for each member to be reintegrated (Up), steps S330 to S360 of the procedure for adding a member are performed, considering the member to be reintegrated as the candidate.

If the departing member was the last member to join the group, in some implementations, the smart contract sends a message to each group member, informing them that the previous group secret must be used as the new group key.

In some implementations, at least one new group secret is computed:
by computing a cryptographic element referred to as group shared secret according to the secret key of a group member and a group public key, or according to the public key of a group member and a group secret key; and
by computing the new group secret key from said group shared secret, for example as being equal to a part of the group shared secret.

When the group shared secret is a vector, for example a coordinate vector of a point of a curve, particularly an elliptic curve, the group secret can include or be a component of this vector.

In the first and in the second aspect of the invention, in some implementations, when a new group public key is registered in the registry, the smart contract assigns a ‘Blind’ status to all remaining members other than the member, referred to as group update member, having triggered this registration; when a member other than the triggering member computes the group secret key, they inform the smart contract thereof; on this basis, the smart contract assigns an ‘Online’ status to said other member; and the method includes at least one procedure implemented using the smart contract, other than a procedure for adding or removing a member, wherein at least one action of the smart contract is carried out according to the member status.

For example, the management method can provide that a member is not allowed to view their previous messages via the smart contract if their status is Blind.

Conversely, when this member subsequently regains Online status, they will then be allowed to perform any action that they were allowed to perform during their period of inactivity, even if for a certain period the member was in ‘Blind’ mode.

In some implementations, a specific procedure is provided for the recovery of messages exchanged during the intermediate period (in ‘Blind’ status).

In these implementations, the management method further includes a procedure for a reconnecting member following a period of inactivity retroactively obtaining at least one group secret key to be obtained, which had been a current group key during said period of inactivity, said retroactive obtaining procedure including the following steps:
S600) based on information published in the registry and/or by querying the smart contract, the reconnecting member determines an authenticator of a key holder member from whom they can obtain said at least one secret key to be obtained;
S610) the reconnecting member requests the key holder member to provide said member with at least one secret key to be obtained;
S620) the key holder member verifies that the reconnecting member was a group member at a time when said at least one requested secret key was the current group secret key, and that the reconnecting member still belongs to the group.
S630) if the result of the verification is positive, the considered key holder member opens a secure auxiliary communication channel with the reconnecting member, for example by following the protocol indicated by French patent application no. 1763394; and
S640) via the secured auxiliary communication channel thus opened, the considered key holder member provides said reconnecting member with at least one requested secret key to be obtained.

In the first or the second aspect of the invention, advantageously the removal procedure can be implemented regardless of the order wherein the members to re-execute the procedure for adding a member execute this procedure for adding a member. Furthermore, this procedure allows the continuous operation of the group, which can take place even if some of the members having to re-execute the procedure for adding a member have not yet executed it (their terminal being switched off, for example).

In the first or the second aspect of the invention, in some implementations, the method for managing a group further comprises a step during which at least one active group member computes a symmetric group key based on a group secret key.

This step allows the group members to have a symmetric key shared by all group members. Such a key allows the implementation of certain protocols, in particular communication protocols, in an easier manner than an asymmetric key such as the group secret key.

These protocols can in particular be message encryption protocols such as AES.

The symmetric key can be computed in different ways.

Thus, in some implementations, to compute said group symmetric key, said at least one active group member:
computes a cryptographic element referred to as group shared secret according to their secret key and a group public key, or according to the public key of a group member and a group secret key; and
computes the symmetric key of the group from said shared group secret, for example as being equal to a part of the group secret.

By extension, according to a third aspect, the invention also relates to a method for encrypted communication within a group, comprising the following steps:
A. the group is formed by implementing any of the methods for managing a group described above;
B. at least one member of the group computes a group symmetric key from the group secret key; and
C. this member receives a message and deciphers it using the group symmetric key, or encrypts a message using the group symmetric key and sends it.

Thus, because each group member is able to compute the group secret key and construct the symmetric key deduced therefrom, each group member is capable of reading the messages exchanged within the group, by deciphering them using the group symmetric key.

In some implementations, in step S50, the member constructs a group secret key (the root node secret key); then they compute a group asymmetric key pair from a 1st part of the group secret, and a group symmetric key from a 2nd part of the group secret.

Information is encrypted or deciphered using the group symmetric key.

When the cryptosystem is based on an elliptic curve, one of the components (on x or on y respectively) can be used to construct the symmetric key, and the other component is used to compute the asymmetric key pair.

### BRIEF DESCRIPTION OF THE FIGURES

Other advantages, aims and particular features of the present invention will become apparent from the following non-limiting description of at least one particular embodiment of the devices and methods according to the present invention, with reference to the appended drawings, wherein:

FIG. 1 is a schematic view of a group of people implementing a method for sharing a group secret according to the present disclosure;

FIG. 2 is a schematic representation of a tree used to organize the members of a group, when implementing a method according to the first aspect of the present disclosure;

FIG. 3 is a schematic representation of a tree used to organize group members, when executing a procedure for adding a member during the implementation of a method according to the first aspect of the present disclosure;

FIG. 4 is a schematic representation of a tree used to organize group members, when executing a procedure for removing a member during the implementation of a method according to the first aspect of the present disclosure;

FIG. 5 is a schematic representation of a tree used to organize the members of a group, when executing a procedure for adding a member during the implementation of a method according to the second aspect of the present disclosure;

FIG. 6 is a schematic representation of a tree used to organize the members of a group, when executing a procedure for removing a member during the implementation of a method according to the second aspect of the present disclosure;

FIG. 7 is a flowchart showing the steps of a procedure for adding a member, in a method for managing a group according to the first aspect of the present disclosure;

FIG. 8 is a flowchart showing the steps of a procedure for removing a member, in a method for managing a group according to the first aspect of the present disclosure;

FIG. 9 is a flowchart showing the steps of a procedure for reconnecting a member who reconnects after a member is removed from the group, in a method for managing a group according to the first aspect of the present disclosure;

FIG. 10 is a flowchart showing the steps of a procedure for adding a member, in a method for managing a group according to the second aspect of the present disclosure;

FIG. 11 is a flowchart showing the steps of a procedure for removing a member, in a method for managing a group according to the second aspect of the present disclosure;

FIG. 12 is a flowchart showing the steps of a procedure for retroactively obtaining a secret key, in a method for managing a group according to the present disclosure; and

FIG. 13 is a flowchart showing the steps of a method for encrypted communication within a group, using a method for managing a group according to the present disclosure.

### DETAILED DESCRIPTION OF THE INVENTION

Non-limiting examples of methods for managing a group and corresponding communication methods according to the present disclosure will now be described.

### General Features of the Method

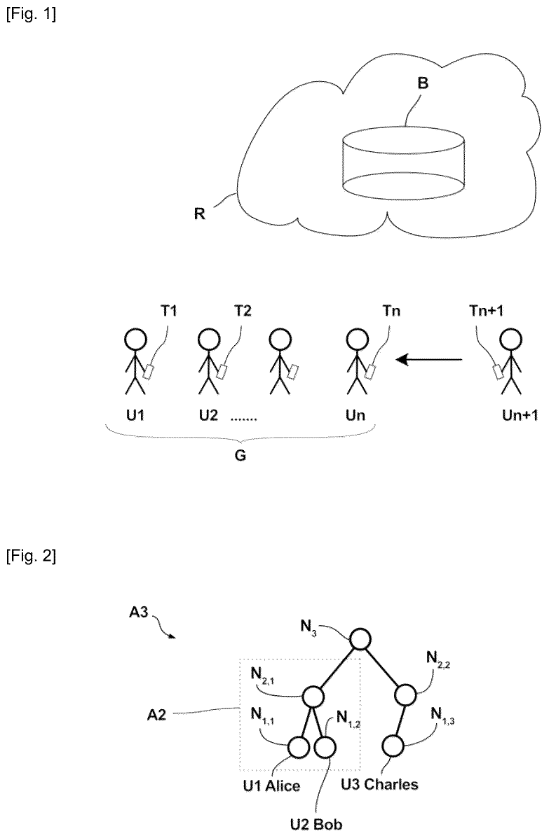

The methods for managing a group according to the present disclosure relate in particular to groups formed in order to be able to exchange messages, such as that illustrated by FIG. 1.

This figure shows a set of parties {U1, U2, U3, . . . . Un}, each party being annotated Ui (i=1 . . . n). These parties form the group G at the considered time. A party Un+1, who is not a member of the group G, seeks to join this group. Each of these parties, which can be a human or a machine, has (or includes) a terminal Ti (i=1 . . . n). Each terminal is an electronic device capable of sending and receiving messages to other parties via a network R, for example the Internet, represented in the form of a cloud in FIG. 1. Each terminal can be, for example, a mobile phone, a computer, etc. The party Un+1 also has a terminal of this type, Tn+1.

Each terminal includes at least one processor capable of running computer applications and a memory. The memory contains at least one communication application, which is used for exchanging messages with the terminals of the other group members.

Although in some implementation modes, terminals can be configured to be continuously capable of exchanging messages, most often each terminal can be either in an ‘active’, or ‘on’ mode, wherein it is capable of exchanging messages with the network, or in an ‘idle’, or ‘off’ mode, wherein it cannot exchange messages. The term ‘message’ includes any exchange of information, in particular terminal update information.

The group G is formed to exchange messages confidentially. For this purpose, a cryptographic element referred to as group shared secret NPK_{Group p} is shared between group members. This group shared secret is recomputed during ‘group update’ operations when necessary in accordance with the procedures of the methods for managing a group according to the present disclosure; at each group update, its index p is incremented. The group shared secret therefore varies over time, first adopting an initial value NPK_{Group1}, then a value NPK_{Group2}, to a value NPK_{Group p} following the p-th computation of the group shared secret.

An asymmetric cryptosystem is chosen for the group to allow the sharing of the secret between the group members by implementing the methods according to the present disclosure.

This cryptosystem may be an elliptic curve cryptosystem, using for example the parameters (p, a, b, G, n and h). These parameters are public. Alternatively, the cryptosystem of the group can also be an RSA cryptosystem; a cryptosystem comprising correction codes; a post-quantum cryptosystem, in particular lattice-based; etc.

A registry, in this instance a blockchain B, is used to carry out registration and communication of certain information between the terminals Ti, in accordance with the present disclosure. This registry can be a public blockchain (accessible by everyone) or a private blockchain (authentication and authorization is required to access it).

The registry is implemented using servers, each server being a computer.

The methods for managing a group according to the present disclosure will now be described.

### First Aspect

By way of example, an implementation of methods according to the first aspect of the present disclosure will now be described in relation to FIGS. 2 to 4.

In this implementation, a binary tree A is used for managing the group.

FIG. 2 shows, by way of example, a tree A which schematically represents a group G. As seen in this figure, at the considered time, the group G includes 3 members: U1, Alice; U2, Bob; and U3, Charles.

The tree A varies over time according to member entries and departures, with each entry or departure resulting in at least one group update. Each group update includes an update of the tree and the associated cryptographic variables.

In the tree A, each node is annotated Nj,k, where j is the level of the node in the tree, and k is the index of the node at the considered tree level j. The single node at the top level s of the tree, annotated Ns, 1 or more simply Ns, is the root node of the tree.

As the tree A is a binary tree, each node has zero, one or two children. The terminal nodes are referred to as ‘leaves’; each leaf in the tree is associated with a group member.

In the tree A, a node shared secret NPKj,k,p and a node asymmetric key pair including a secret key SKj,k,p and a public key PKj,k,p are associated with each node Nj,k; p being the current (i.e. at the considered time) index of the group secret.

The public key PKj,k,p can be computed from the secret key SKj,k,n using the cryptosystem chosen for the group, in a manner known per se. The secret key SKs,1,p associated with the root node Ns is the group secret key SK_{group p}.

In the exemplary implementation described here, the cryptosystem chosen for the group is an elliptic curve cryptosystem, using the parameters (p, a, b, G, n, and h).

The node secret key SKj,k,p is derived from the node secret NPKj,k,p by a derivation function. Any suitable derivation function can be chosen; and in particular, any derivation function that generates the node secret key SKj,k,p according to at least part of the information contained in the node secret NPKj,k,p.

The derivation function can simply be the identity function (the node secret key is then equal to the node secret).

The derivation function must of course be held by any party having to compute a new value of the node secret key.

In the embodiment described here, for a node Nj,k (‘parent node’) having two children, the new value of the node secret and the new value SKj,k,p+1 of the secret key of the node Nj,k are computed as follows during a group update of index p+1:

It is assumed that at the time of this update, the two children of the node Nj,k are the nodes Nj−1, k1−1 and Nj−1,k1.

The new value for the node secret NPKj,k,p+1 is computed by an encryption function combining the public key of one of the children and the secret key of the other child. This function is any encryption function Enc of an asymmetric cryptosystem (Enc,Dec) that verifies the property, for two asymmetric key pairs (PK1,SK1) and (PK2,SK2):

$$Enc ( PK 1 , SK 2 ) = Enc ( SK 1 , PK 2 ) ,$$

In the present case, the node secret can therefore be computed by either of the following formulas:

$$NPKj , k , p + 1 = Enc ( SKj - 1 , k 1 , p ; PKj - 1 , k 1 , p ) = SKj - 1 , k 1 , p PK - 1 , k 1 , p = Enc ( PKj - 1 , k 1 , p ; SKj - 1 , k 1 , p ) = PKj - 1 , k 1 p SKj - 1 , k 1 , p$$

This property allows a party whose attachment chain contains one of the child nodes Nj−1, k1−1 or Nj−1, k1, and who for this reason holds the secret key of this child node, to compute a new value (of index p+1) of the shared node secret for the parent node Nj,k.

Conventionally, the secret key SKj,k,p+1 for the node Nj,k, is deduced from the node shared secret as being equal to the component on x of NPKj−1,k1,p:

$$SKj , k , p - 1 = NPKj , k , p ( x ) .$$

The corresponding public key of the node N2,1 is obtained from the secret key SK2,1,2 by the formula: PK2, 1,2=SK2, 1,2 ●G.

In this equation:
the operator ‘●’ indicates the multiplication operation in the space of the elliptic curves, which can be implemented by an addition repeated the number of times indicated by the scalar. Therefore, the public key PK2,1,2 indicated by the multiplication operation above is equal to (((G+G)+G)+ . . . +G), the addition is repeated SK2,1,2 times, the addition operation ‘+’ being defined in the space of the elliptic curves; and
G is the generator point on the considered elliptic curve, which makes it possible to generate all the points of the elliptic curve in the discretized space.

The y component of NPK2,1,2 is then chosen as the symmetric key EncK2 for the exchanges of messages in the group G2: EncK2=NPK2,1,2(y).

The above procedure makes it possible to compute the cryptographic elements of a parent node Nj,k, from the secret key of one of the child nodes Nj−1, k1−1 or Nj−1, k1, the public key of the other child node being available in the registry, for any node Nj,k having two children.

Other functions can be chosen to derive a secret key of the parent node from the secret key of one of the child nodes and the public key of the other child node. As a general rule, any function usable (or used) for implementing the Diffie-Helman protocol can be used to perform this function.

If, conversely, a parent node Nj,k has a single child Nj−1,k1, the secret key SKj,j,p+1 of the node Nj,k is computed during an update according to the only secret key of its child SKj−1,k1,p+1, for example by being equal to the latter: SKj,k,p+1=SKj−1,k1,p+1.

Advantageously, this procedure can be repeated by a group member step by step to successively compute the cryptographic elements, and in particular the secret keys, of all the nodes of their attachment chain, in the direction from the terminal node associated with the member to the root node.

In the asymmetric key pairs associated with the different nodes, the public keys are registered in the registry and are therefore freely accessible (at least for members with access to the registry). Conversely, as will be detailed below, for each node, only the member(s) whose attachment chain contains the node have or are capable of restoring the node secret key of the node.

### Adding Members

The procedure for the entry of new members into the group G according to the management method will now be described within the scope of the initial phases of the formation of the group G.

As a general rule, the entry of a new member into the group results in the execution of a procedure for adding a member, and optionally the execution of one or more reconnection procedures. The procedure for adding a member results in an update of the group and therefore recomputing of the group secret. The reconnection procedure therefore allows any group members inactive at the time the procedure for adding a member was executed to be able to obtain the new group secret and therefore rejoin the group.

During an initialization phase (p=1), the 1^{st} member U1 of the group, Alice, creates the group G by deploying a smart contract SC in the registry B. Alice therefore becomes the group administrator.

Using the cryptosystem, Alice generates her personal asymmetric key pair, annotated SKAlice/PKAlice. Alice registers her public key PKAlice in the registry and is registered by the smart contract as having ‘Online’ status.

This registration can be carried out in different ways.

If the registry is a Bitcoin type blockchain, a temporary public key can be registered in the blockchain using the Bitcoin protocol script OP_s. Such use of this script can be implemented based on French patent application no. 1763393. As the Blockchain content is accessible to the group members, each of them has access to the public keys thus deposited based on knowledge of their account address, which proves that the key belongs to them.

If the registry is an Ethereum type blockchain, the ephemeral public key can be registered in the blockchain using a smart contract. Such an implementation can be carried out based on French patent application no. 1763394.

Alice's secret key is the group secret of index p=1:

$${SK}_{group 1} = SKAlice .$$

In a second phase, Bob joins the group as a second member U2, which results in a group update (p=2).

Using the cryptosystem, Bob generates his personal asymmetric key pair, annotated SKBob/PKBob.

The public keys PKAlice and PKBob are derived from the secret keys SKAlice and SKBob, respectively, by the following formulas:

$${PK}_{Alice} = {SK}_{Alice} {GPK}_{Bob} = {SK}_{Bob} G$$

where G is the generator point of the elliptic curve cryptosystem represented by the parameters (p, a, b, G, n and h).

Bob also has an authenticator accuU2 that allows him to be authenticated with the smart contract SC.

The procedure for adding a member is executed to allow Bob to join:

In step S10, Bob sends the smart contract SC his request for entry into the group by attaching his authenticator accuU2 and his public key PKBob to his request.

In step S20, the smart contract registers in the registry the entry into the group G of a new member having the authenticator accuU2 and the public key PKBob.

In view of the information contained in the registry, Bob then determines (step S30) that his attachment chain in the tree A contains only the root node N2,1.

In step S40, Bob computes the node secret key for this node from his personal private key SKBob and Alice's public key PKAlice:
Bob computes the node secret, NPK2,1,2: NPK2,1,2=SKBob●PKAlice
He then deduces the secret key SK2,1,2 for the node N2,1, which is the component on x of NPK2,1,2: SK2,1,2=SK_{group 2}=NPK2,1,2(x).
He then computes the public key PK2,1,2 from the secret key SK2,1,2: PK2,1,2=SK2,1,2●G.
He then deduces the current symmetric key EncK2 for message exchanges in the group G, which is the component on y of NPK2,1,2: EncK2=NPK2,1,2(y).

In step S50, Bob publishes in the registry the group public key PK2,1,2 that he has just computed. Bob's status is ‘Online’, while Alice's status is set to ‘Blind’.

In step S60, the smart contract sends Alice a group key update message.

In step S70, on receipt of this message, Alice determines the node secret key(s) that she needs to recompute: these are the secret keys of the common nodes with her attachment chain and following Bob's attachment, i.e. the node N2,1.

Alice then computes the secret key of the node N2,1 by following the procedure described above. Thanks to the commutative property of elliptic curve cryptosystems, she obtains the same value for the secret key SK2,1,2 as that computed by Bob. She informs the smart contract of this and is returned to ‘Online’ status.

She also computes the group symmetric communication key, EncK2, with the formula: EncK2=NPK2,1,2(y).

Alice and Bob then exchange messages using the symmetric communication key EncK2 as the encryption key for the messages they exchange.

These messages can be encrypted with any known symmetric encryption algorithm such as AES.

In a third phase, Charles joins the group as a third member U3.

He is added at level 1 to node N1,3. A node N2,2 and a new root node N3,1 (or N3) are created so that Charles can have an attachment chain extending to the root node. The node N2, 1 is the first child of the root node N3, and the node N2,2 is the second child thereof.

Charles' attachment chain includes the nodes N2,2 and N3.

The procedure for adding a member described above is then executed to allow Charles to join the group G.

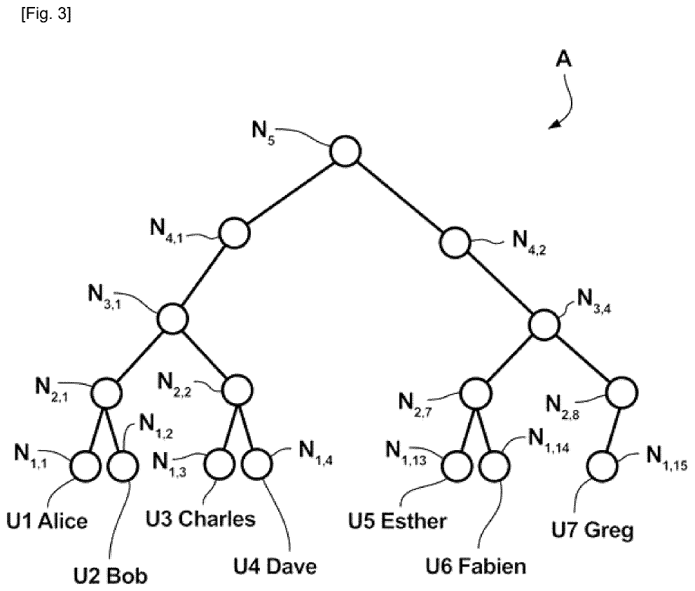

The procedure for adding a member to the group G will now be described more generally in the example illustrated by FIG. 3.

This procedure will be illustrated at a time when the group is the group G described above, at an update index p.

At the considered time, the group G includes six members Uᵢ, i=1 . . . 6 called Alice, Bob, Charles, Dave, Esther and Fabien, incorporated in the tree A.

A candidate U7, Greg, wants to join the group.

To allow him to become a group member, the procedure for adding a member is executed for Greg.

The members are added to the tree A in accordance with the rules for forming the tree A. Any appropriate set of rules can be chosen for forming the tree. This set of rules is chosen in such a way as to allow each group member to know at any time, from the registry, the structure of the tree. This set of rules can be public: each group member, at any time, from the registry, can know the structure of the tree. Alternatively, it can be private. It is then known at least from the smart contract: it is then the smart contract that informs the members of their attachment chain and where applicable other information they need relating to the tree structure.

The entry of a new member, as will be detailed, results in some cases in the addition of an additional level in the tree, and/or the addition of one or more new node(s), and in any case the addition of a new leaf corresponding to the new member. At the considered time, the tree A6 includes the 6 members U1-U6, and 14 corresponding nodes referenced N1,1; N1,2; N1,13; N1,14; N2,1; N2,2; N2,7; N3,1; N3,4; N4,1; N4,2; N5.

In this case, the rules for forming the group include a rule of non-replacement in the tree of departing members and hence, the tree is not complete. Thus, some nodes, such as the nodes N3,2 and N4,2 have a single child or are even missing, following departure of the group members that were attached to these nodes from the group.

The rules for forming the tree furthermore necessitate that each of the group members (U1-U6) be necessarily attached to a level 1 node (However, in other embodiments, members can be attached to higher level nodes. For example, the new member could be attached to the node N4,1).

Due to this rule, the new member U7 is added to the tree at level 1, in the position with an index immediately above the position of the last member to join, U6, still present in the group. Since the tree A did not contain a node N2,8 during the current update (index p), the node N2,8 is created. The member U7 is therefore added to a node N1,15. Thanks to the creation of the node N2,8, he has a complete attachment chain formed by the nodes N2,8; N3,4; N4,2 and N5.

Each of the members U1-U6 has an asymmetric key pair comprising a secret key ESKi and a public key EPKi derived from the secret key ESKi using the asymmetric cryptosystem, i.e. the key pairs SK_{Alice}/PK_{Alice}, SK_{Bob}/PK_{Bob}, SK_{Charles}/PK_{Charles}, SK_{Dave}/PK_{Dave}, SK_{Esther}/PK_{Esther}, SK_{Fabien}/PK_{Fabien}, respectively. Greg also has such a key pair SK_{Greg}/PK_{Greg}.

At the time when Greg initiates the procedure for adding a member to join the group G (as at any time), each of the active group members has the node secret key SKj,k,p of each of the nodes Nj,k of their attachment chain. Furthermore, for each node Nj,k of the tree A, a public node key PKj,k,p is registered in the registry.

The addition of the new member U7, Greg, to the group results in the following operations:

In step S10, Greg sends the smart contract his request for entry into the group, attaching to this request his authenticator acc_{U7} and his personal public key PK_{Greg}. In this embodiment, he sends this request directly to the smart contract. In other embodiments, he could send his request to a group administrator, who, after having carried out appropriate verifications, would send the request to entry to the smart contract.

In step S20, the smart contract registers in the registry the entry into the group G of the new member U7 having the authenticator acc_{Greg} and the public key PK_{Greg}.

In step S30, Greg determines the list of nodes of his attachment chain in the tree, namely the list N2,8; N3,4; N4,2; N5.

In step S40, in a neighbor-to-neighbor manner, Greg computes the node secret key then the public node key for each node in his attachment chain, from the node of the tree to which he is directly attached to the root node N5. As seen previously, in the embodiment described here, this computation is indirect: to compute the secret key of index p+1 of a node Nj,k having two children, Greg first computes the node secret NPKj,k,p+1, then derives therefrom the node secret key SKj,k,p+1, followed by the public node key PKj,k,p+1. If, conversely, a node of the attachment chain has only one child (such as the node N2,8), in this case the node secret, the public and secret node keys assigned to this node are equal to the corresponding cryptographic elements of the child. In particular, SK2,8,p+1=SK_{Greg}.

In step S50, Greg publishes in the registry the public keys of the nodes N2,8; N3,4; N4,2 and N5 computed in step S50. All the public keys of the tree A are therefore thus updated.

However, to allow all members of the group to exchange messages, their keys must then be updated.

For this purpose, in step S60, the smart contract sends a group key update message to each pre-addition group member.

In step S70, on receipt of the group key update message, in a neighbor-to-neighbor manner, each active pre-addition group member, i.e. each of the active members among the members U1-U6, computes the node secret key for each node of their attachment chain that is also part of Greg's attachment chain, in the direction from the node of the tree to which they are directly attached to the root node N5 (upward direction in FIG. 3). To do this, they perform similar computations to those performed by Greg in step S40.

Each active group member then computes the symmetric group communication key EncKp+1, in step S80.

Consequently, each active group member is therefore capable of sending and/or receiving messages under symmetric encryption using this key with the other active group members.

### Procedure for Reconnecting Inactive Members

If a group member is inactive when the procedure for adding a member is executed, they cannot perform step S70 at that time. Consequently, when they reconnect (typically by switching on their terminal Ti), because the secret and private group keys have been recomputed, they do not have these keys and cannot exchange messages with the other group members.

To remedy this situation, they perform the following reconnection procedure. When the group member (and therefore, when each group member) reconnects, they consult their messages. If they have received a member addition message, they then execute steps S70 and S80, which allows them to obtain the up-to-date secret keys for all the nodes of their attachment chain, as well as the symmetric group key EncKp+1, which then allows them to exchange messages with the other group members.

### Removing a Member

When a group member (referred to as ‘departing member’) leaves the group G (at an update index p), a procedure for removing a member is executed to ensure that after the member leaves, the member no longer has the secret symmetric key EncKp used for encrypting messages in the group and hence, can no longer have access to the messages exchanged by the group. More generally, the aim of the removal procedure is to refresh the group secret key SK_{group p}, so that the departing member can no longer access confidential information relating to the group.

To refresh this secret key, it will be necessary to recompute the node secret key for each of the nodes of the attachment chain of the departing member.

To this end, the removal procedure includes carrying out the following operations when it is decided to remove the departing member:

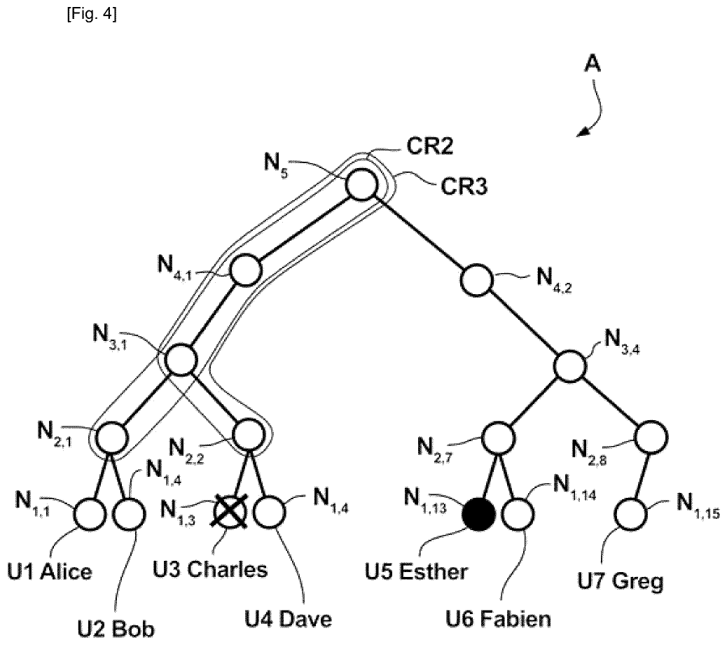

By way of example, let us take the case where Charles (group member U3) leaves the group G, the tree A of which is shown in FIG. 4. Charles' attachment chain CR3 includes the nodes N2,2; N3,1; N4, 1; N5.

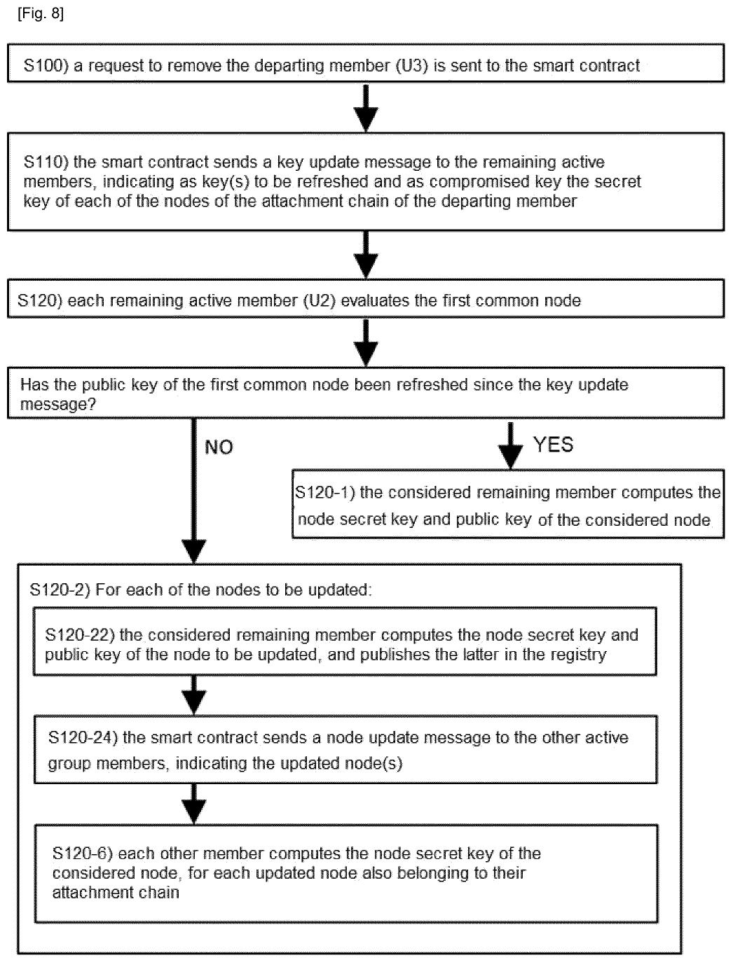

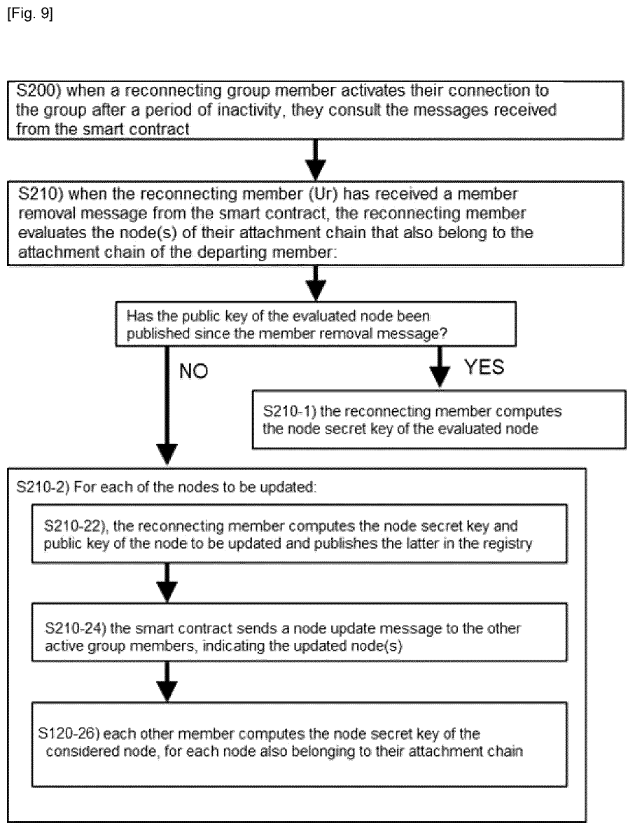

The steps of the procedure for removing a member are shown in FIG. 8. FIG. 4 shows the tree A when the removal procedure is executed following Charles' departure.

In step S100, Charles, directly or optionally via Alice, the group administrator, sends the smart contract a removal request.

In step S110, the smart contract sends a key update message to each remaining group member, indicating as key(s) to be refreshed and as compromised key the secret key of each of the nodes of the attachment chain of the departing member Charles (U3). On receipt of this message, each group member considers the public key of each of the nodes in Charles attachment chain CR3 as compromised.

In step S120, each remaining active member evaluates the node, known as the first common node, which is the node of their attachment chain that is furthest from the root node and which also belongs to the key chain to be refreshed.

It is assumed that the first considered remaining member who performs this procedure is Bob (U2). Bob's attachment chain CR2 includes the nodes N2,1; N3,1; N4,1; N5.

The first common node is therefore the node N3,1.

At this time, the public key of the first common node, N3,1, has not been recomputed since the key update message: it is therefore a compromised key. Bob deduces therefrom that he must execute step S120-2, composed of steps S120-22, S120-24 and S120-26: He must recompute the public keys of the node N3,1 as well as all the higher nodes in his attachment chain CR2 (i.e. the nodes N4, 1 and N5).

Thus, in step S120-2, for each of the nodes (referred to as ‘updated nodes’) N3,1; N4,1 and N5, Bob (the considered remaining member) computes the node shared secret, and deduces the public key and the secret key of the node, and publishes the public key in the registry. During the computation for the node N3,1, as the key N2,2 is compromised, the node N2,2 is considered as non-existent during the computation of the node shared secret NPK3,1,p+1. In other words, the node N3,1 is considered for this computation as a node having only one child (the node N2,1). The secret key of the node N3,1 is therefore computed only according to the secret key held by Bob of the node N2,1. No information from the compromised public key of the node N2,2 is therefore used.

The secret keys of the nodes N4,1 and N5 are then computed. Therefore, this gives:

$$SK 4 , 1 , p + 1 = SK 3 , 1 , p + 1 = SK 2 , 1 , p + 1$$

The node key NPK5 is computed according to SK4,1 and PK4,2 (the right branch of the tree having no compromised key).

The public keys PK3,1,p+1, PK4,1,p+1 and P5,p+1 are published in the registry.

As public keys PK3,1; PK4,1 and PK5 have been recomputed, in step S120-24, the smart contract then sends a key update message to each other group member (other than the departing member (Charles)) and other than the considered remaining member (Bob)), indicating as keys to be refreshed the key of at least each of the updated nodes that are also part of the attachment chain of said other considered member. This message is therefore sent to Alice, Dave, Fabien and Greg (Esther being absent), who are therefore the ‘other members’. For example, for Fabien and Greg, the message may simply indicate that the public key PK5 has been recomputed.

On receipt of the message sent in step S120-26, every other active member computes the node secret key for each node of their attachment chain which is also an updated node, in the direction from the node of the tree to which they are directly attached to the root node.

It is assumed that Dave is the second member of the group who responds to the receipt of the key update message sent in step S110.

Dave responds to the messages sent in steps S110 and S120-26 by performing the following steps:

For Dave, the first common node (i.e. the lowest node in his attachment chain, a key of which is indicated in the message sent in step S110 as key to be refreshed and as compromised key) is the node N2,2.

In step S120, Dave (as considered remaining member), evaluates this first common node N2,2.

The public key of the node N2,2 has not been refreshed since the message sent in step S110.

Therefore, Dave must perform step S120-2.

The nodes referred to as ‘updated nodes’ are the nodes N2,2; N3, 1; N4, 1; N5.

Since node N1,3 has been removed (due to Charles' departure), the public and secret keys of the node NPK2,2,p+1 are equal to Dave's public key and secret key PK_{Dave} and SK_{Dave} respectively.

In step S120-22, Dave therefore computes in a neighbor-to-neighbor manner (or step by step), the node shared secrets and the node secret and public keys successively for the nodes N3,1; N4,1; N5.

In step S120-24, the smart contract sends a key update message at least to each other active group member, indicating as keys to be refreshed the secret key of each of said updated nodes, therefore the keys of the nodes N2,2; N3,1; N4, 1; N5.

In step S120-26, each of the other members, where applicable, updates their keys along their attachment chain.

In particular, Bob must recompute the secret and public keys for the nodes of his attachment chain for which the secret and public keys have been recomputed: he therefore recomputes the keys for the nodes N3,1; N4,1 and N5.

The other active group members, Alice, Fabien and Greg, then also recompute the secret and public keys for the nodes of their respective attachment chains for which the secret and public keys have been recomputed.

In the case of Fabien or Greg, this computation simply consists of recomputing the node shared secret, followed by the secret and public keys, for the node N5.

Alice received the message sent in step S110, indicating as keys to be refreshed and as compromised key the secret key of each of the nodes N2,2; N3,1; N4,1; N5.

She received during steps S120-24 node update messages initiated by Bob and Dave indicating as updated nodes the nodes N3,1; N4, 1 and N5 respectively, followed by the nodes N2,2; N3,1; N4,1 and N5.

For Alice, the first common node (between her attachment chain and that of the departing member Bob) is the node N3,1. Alice determines that the public key of this node has been recomputed from the message sent in step S110. Alice therefore executes step S120-1.

In step S120-1, for each node of her attachment chain, from the first common node N3,1 to the root node N5, Alice (as considered remaining member) computes the shared secret of the considered node, and deduces the public key and the node secret key of the considered node. She thus recomputes the cryptographic elements for the nodes N3,1; N4,1; N5. Using the secret key of the node N5, she computes the up-to-date value of the symmetric group communication key EncK_{group}.

These operations allow Alice to exchange messages with the rest of the group.

The procedure for reconnecting a member who was inactive when the departing member (Charles) was removed is illustrated in FIG. 9, in the case of Esther reconnecting.

Subsequently, Esther activates her terminal to reconnect to the group.

Esther then receives the messages sent in step S110 and in the different steps S120-24. In the context of the departure of the member U3, Charles, the first common node is the node N5.

In step S200, when Ester (as ‘reconnecting member’) activates her connection to the group, she consults the messages received from the smart contract.

In step S210, because she received from the Charles' removal message, in a neighbor-to-neighbor manner (or step by step), Esther evaluates the node(s) of her attachment chain that also belong to the attachment chain of the departing member, i.e. in this case the node N5.

In step S210, Esther evaluates the status of this first common node N5: she determines that the public key of this node has been refreshed since the message sent in step S110.

Esther then performs step S210-1: she computes the group shared secret for the node N5, and deduces the secret key therefrom, followed by the public key for the node N5. Finally, she deduces the group symmetric communication key EncCK_{group}.

Conversely, in the case where for one or more evaluated nodes, Esther would observe that the public key of this node has not been refreshed since the message sent in step S110, Esther would carry out steps S210-22, S210-24 and S210-26 indicated above, which are similar to the steps in step S120-2.

According to one variant, if the procedure for removing a member is executed during a period during which one of the group members, the following reconnection procedure is followed when reconnecting this member:

The procedure for adding a member to the group is carried out for the member in question as if they were joining the group for the first time. However, suitable measures are preferably taken to ensure that the member in question retains the history of their interactions with the group.

### Accessing Messages Exchanged During a Period of Inactivity

When a member is inactive when a new member is added to the group or a member is removed from the group, due to the refresh of the group secret key, the inactive member cannot access messages exchanged within the group after the group secret key has changed following the departure or addition of a member.

When the member reconnects, as explained previously, they compute the new group secret key and therefore the group communication key derived therefrom: this gives them access to the new messages exchanged within the group.

However, this does not give them access to messages exchanged between the addition or removal of the group member and the time of their reconnection to the group.

In order to allow this member, referred to as reconnecting member, to access these messages, the following procedure, referred to as access procedure, can be executed.

By way of example, let us take the case of the reconnection of the member U5, Esther, who was disconnected when the procedure for removing the member U3, Charles, was executed.

As indicated, in step S120, each of the remaining active group members performed their update procedure.

Subsequently, at the time of her reconnection, the member U5, Esther, performed the reconnection procedure described above to obtain the new root node secret key and the new group communication key.

In addition, the access procedure described below will allow Esther to access the messages exchanged from the procedure for removing a member until she executed the reconnection procedure.

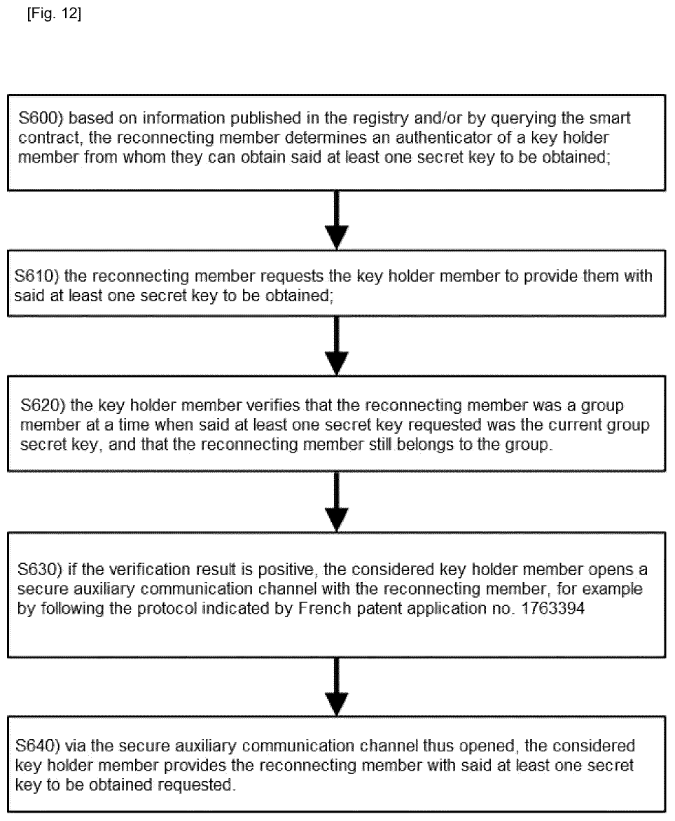

This access procedure includes the following steps, illustrated by FIG. 12:

In step S600, based on the information published in the registry concerning member additions or removals and/or publications of public keys, and/or by querying the smart contract, Esther (as ‘reconnecting member’) determines the authenticator(s) of one or more members (‘key holder members’) from whom she can obtain the temporary secret key(s) used during her period of inactivity after the departing member was removed.

She then obtains the group secret key(s) she is lacking by contacting the identified key holder member(s) via a secure communication channel.

When she contacts a key holder member, she follows the following procedure:

In step S610, she (as reconnecting member) requests the key holder member to provide her with one or more secret keys that they have and that the reconnecting member would like to obtain.

In step S620, to respond to this request, the key holder member verifies the legitimacy of the request of the reconnecting member.

Based on the information published in the registry concerning additions or removals of members and/or publications of public keys, and/or by querying the smart contract, they verify in particular:
that the reconnecting member was authorized to access the requested secret key(s), in that they were a group member at a time when the requested secret key(s) was the current group secret key(s); and
that the reconnecting member is still part of the group.

In step S630, if the considered key holder member has concluded at the end of step S620 that the request of the reconnecting member is legitimate, they open a secure auxiliary communication channel with the reconnecting member. Any appropriate security method can be chosen for this communication channel. This secure communication channel can be opened for example by exchanging keys according to the Diffie-Hellmann protocol, following the protocol indicated by French patent application no. 1763394.

In step S640, via the secure auxiliary communication channel thus opened, the considered key holder member then provides the reconnecting member with the requested secret key(s).

On receipt thereof, the reconnecting member is then capable of reading the messages exchanged during the period when this key or these keys were the current group key(s).

### Second Aspect

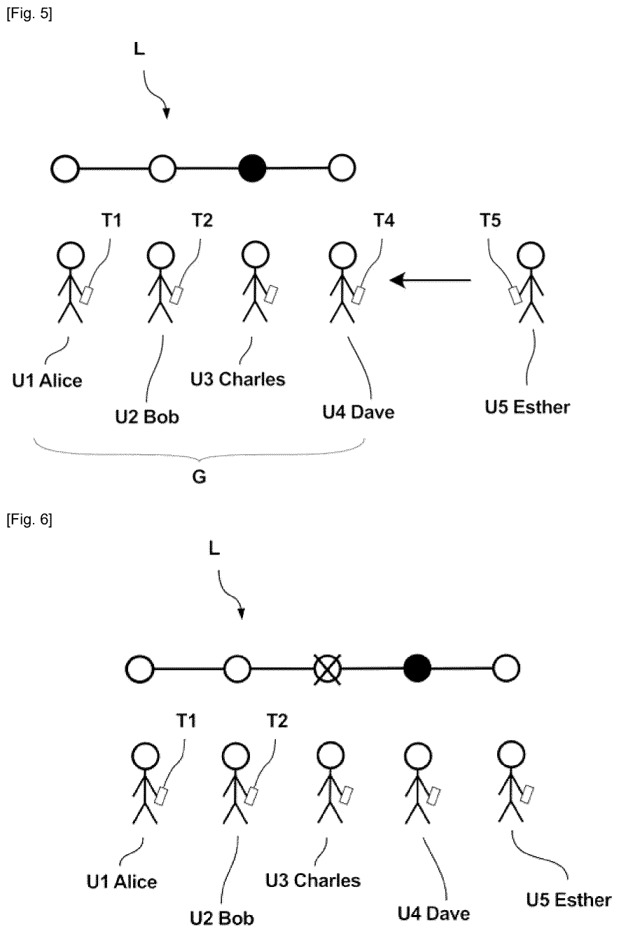

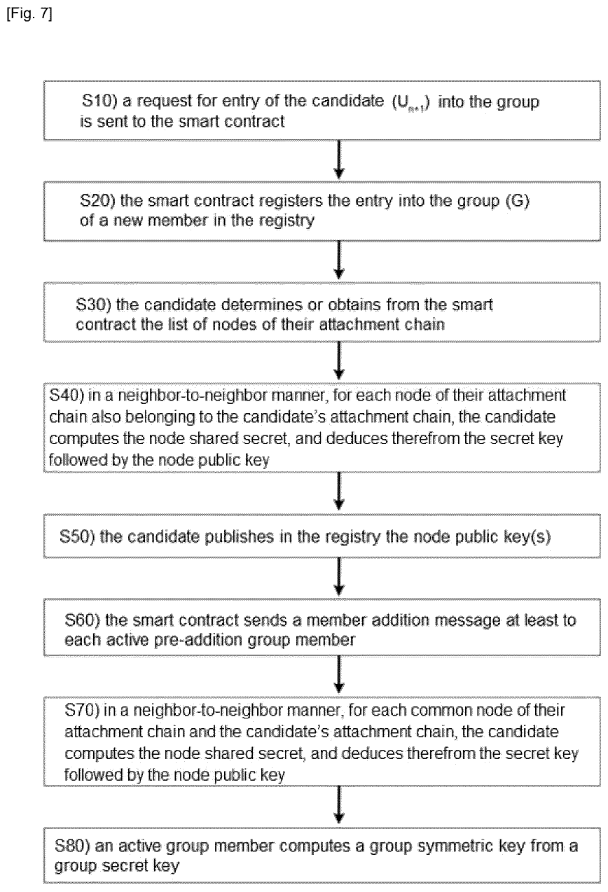

By way of example, an implementation of methods according to the second aspect of the present disclosure will now be described in relation to FIGS. 5 and 6.

In this implementation, the group members Ui are not managed using a binary tree, but using a chained list, i.e. a sequence of consecutive elements.

The general features of the method described above can also be implemented in the case of group management with a chained list.

As above, the group secret key that the management method allows all group members to hold in a shared manner is used by each to compute a symmetric communication key for the group, EncKp (at the group index p), which is computed from the group secret key SK_{group p}.

The key EncKp is used by each group member to encrypt and decipher messages exchanged with the other group members.

In this embodiment, a chained list L is used for managing the group.

FIG. 5 shows, by way of example, a list L which schematically represents a group G. As seen in this figure, at the considered time, the group G includes 4 members: U1, Alice; U2, Bob; U3, Charles and U4, Dave.

The list L varies over time according to member entries and departures, with each entry or departure resulting in at least one group update. Each group update includes an update of the list L and the associated cryptographic variables.

In the list L, a group asymmetric key pair including a secret key SK_{group p} and a public key PK_{group p} is generated and associated with the group G during the first update; p is referred to as the current index (i.e. at the considered time) of this group asymmetric key pair.

The group public key PK_{group p} can be computed from the secret key SK_{group p} using the cryptosystem chosen for the group, in a manner known per se.

Each group public key PK_{group p} is registered in the registry and is therefore freely accessible (at least for members with access to the registry).

In the exemplary implementation described here, the cryptosystem chosen for the group is an elliptic curve cryptosystem, using the parameters (p, a, b, G, n, and h).

It is therefore a cryptosystem of the same type as that described in the first implementation. Therefore, unless otherwise indicated, the key computation operations are performed for the second implementation as for the first implementation.

In particular, in this implementation, the computation of new group secret and public keys is performed indirectly:

Initially, a new group shared secret (of index p+1) NPK_{group p+1} is computed by an encryption function combining:
the public key of a new group member and the secret key of the group of previous index (p); or
the secret key of the new group member and the public key of the group of previous index (p).

The encryption function Enc of the asymmetric cryptosystem (Enc,Dec) must verify the same property as that defined in the first implementation.

The new group secret key SK_{group p+1} is derived from the group shared secret NPK_{group p+1} by any suitable derivation function.

The new group secret key SK_{group p+1} can thus be deduced from the shared group secret as being equal to the component on x of NPK_{group p+1}:

$${SK}_{group p + 1} = {NPK}_{group p + 1} ( x )$$

Furthermore, the new group public key PK_{group p+1} is obtained from the secret key SK_{group p+1} with the formula: PK_{group p+1}=SK_{group p+1}. G.

The derivation function must of course be held by any party having to compute a new value of the group secret key.

The group symmetric key used to allow the exchange of messages between group members is then computed as being equal to the second component (the component on y) of the group shared secret. It is therefore provided by the equation: encK_{group p+1}=NPK_{group p+1}(y).

### Adding a Member

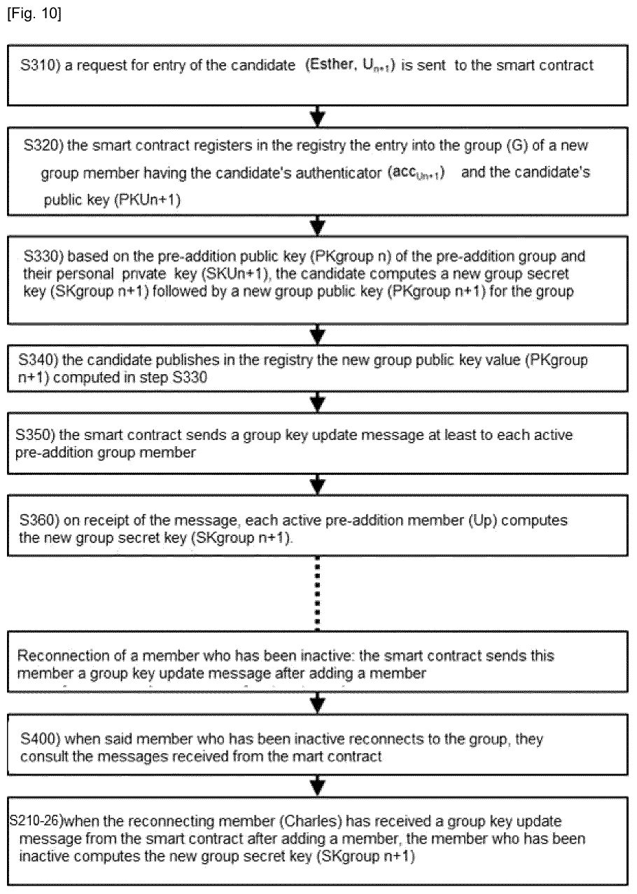

The procedure for the entry of new members into the group G according to the management method will now be described by way of example at the time shown in FIG. 5, when a candidate, Esther, joins the group G. The steps of the procedure are illustrated by FIG. 10.

In this initial situation, referred to as ‘pre-addition’, each of the group members (Alice, Bob, Charles, Dave) holds the group secret key SK_{group 4} (it is assumed that no member has been removed since the group was created, therefore the group index is p=4).

The pre-addition public key (PK_{group 4}) of the pre-addition group is registered in the registry.

The addition procedure for adding Esther to the group comprises the following operations:

Previously, Esther had an asymmetric key pair comprising a personal secret key (SK_{Esther}) from which her personal public key (PK_{Ester}) was computed using the group cryptosystem.

Moreover, at the time when the procedure for adding a member is executed, Alice, Bob and Dave are active but conversely, Charles is inactive.

In step S310, Esther submits her request for entry to the group administrator, Alice.

Alice verifies that Esther meets the conditions for entry into the group. In this case, she concludes that these conditions have been met and sends the request for entry to the smart contract, attaching Esther's authenticator (acc_{Esther}) and personal public key (PK_{Ester}).

In step S320, the smart contract registers Esther in the registry as a new group member, in particular by registering her authenticator acc_{Esther} and her public key PK_{Esther}.

In step S330, based on the pre-addition public key (PK_{group 4}) of the pre-addition group and her personal private key (SK_{Esther}), the candidate, Esther, computes a new group secret key value (SK_{group 5}) followed by a new group public key value (PK_{group 5}) for the group G.

In step S340, Esther publishes in the registry the new group public key value (PK_{group 5}) computed in step S330.

In step S350, the smart contract sends a group key update message, in this embodiment, to all active pre-addition group members, namely Alice, Bob and Dave.

In step S360, on receipt of this message, based on the pre-addition secret key (SK_{group 4}) of the pre-addition group and Esther's personal public key PK_{Esther}, each member computes the new group secret key value SK_{group 5} by applying the formula given above, and thus: SK_{group 5}=SK_{group 4}●PK_{Esther}.

In step S370, each member then additionally computes the group symmetric communication key EncK5, which allows them to continue to exchange messages with the group, now comprising Esther.

Thus, by construction, the list of group members is the list organized in chronological order of their entry dates or instead their last entry dates into the group.

In some implementations, the positions in the group of the group members are indexed and tracked by the smart contract.

### Procedure for Reconnecting Inactive Members Following the Addition of a Member

Some time later, Charles (as an example of an inactive member) reconnects to the group.

The smart contract detects this reconnection (or Charles sends a message to the smart contract indicating his reconnection) and sends Charles a group key update message.

(According to one variant, in step S350, the group key update message is sent to all pre-addition group members, whether they are active or not).

Charles executes the reconnection procedure by performing the following operations:

In step S400, Charles consults the messages received from the smart contract. He therefore notices that the smart contract has sent him a group key update message.

In step S410, because of this message, based on the pre-addition secret key (SK_{group 4}) of the pre-addition group, which he holds, and Esther's personal public key (PK_{Esther}), Charles in turn computes the new group secret key value (SK_{group 5}).

He then computes the group symmetric communication key EncK5, which allows him to exchange messages with the group again.

### Removing a Member

When a group member (referred to as ‘departing member’) leaves the group G (at an update index p), a procedure for removing a member is executed to ensure that after the member leaves, the member no longer has the secret symmetric key EncK_{group p} used for encrypting messages in the group and hence, can no longer access the messages exchanged by the group. More generally, the aim of the removal procedure is to refresh the group secret key SK_{group p}, so that the departing member can no longer access confidential information relating to the group.

The following removal procedure is therefore executed when it is decided to remove a departing member:

An example is taken of the case where Charles (group member U3) leaves the group G, the tree A of which is shown in FIG. 6.

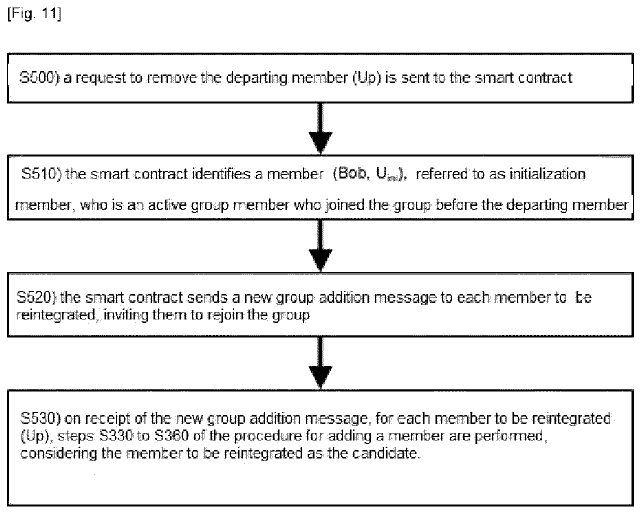

FIG. 6 shows the tree A when the removal procedure is executed following Charles' departure. The steps of the procedure are illustrated by FIG. 11.

In step S500, Charles, or optionally Alice the group administrator, sends the smart contract a request to remove the departing member, Charles.

In step S510, the smart contract identifies a member Uini, referred to as initialization member, who is an active group member who joined the group before the departing member, Charles. In the example described here, Bob is identified as initialization member Uini.

In step S520, the smart contract sends a new group addition to each group member who joined the group after the initialization member (Bob), except Charles of course, inviting him to rejoin the group.

Each of the members to whom these messages are sent is referred to as ‘member to be reintegrated’; the main steps of the procedure for adding a member will have to be executed for the member to be reintegrated to allow the group secret key update.

Hence, in step S530, for each member to be reintegrated (Up), steps S330 to S360 of the procedure for adding a member are performed, considering the member to be reintegrated as the candidate.

Once these steps have been performed, each member to be reintegrated then computes the group symmetric communication key, EncK_{group p+1}, from the new group secret key.

By thus successively recomputing the group secret key, from the initialization member, for each of the members to be reintegrated, a new group secret key value is progressively computed. This value is shared between all active group members, but is not known to the member removed.

### Procedure for Reconnecting Inactive Members Following the Removal of a Member

As can be seen in FIG. 6, at the time of the removal procedure, Dave is inactive.

Some time later, Dave (as an example of an inactive member) reconnects to the group.

The smart contract detects this reconnection (or Dave sends a message to the smart contract notifying it of his reconnection) and sends Dave a new group addition message (According to one variant, in step S420, the new group addition message be sent to all group members (except the removed member)).

Dave executes the reconnection procedure by performing the following operations:

Dave consults the messages received from the smart contract. He therefore notices that the smart contract has sent him a new group addition message.

Hence, in the next step, steps S330 to S360 of the procedure for adding a member are performed, considering Charles (as member to be reintegrated) as the candidate.

Once these steps have been performed, Charles then computes the group symmetric communication key, EncK_{group p+1}, from the new group secret key.

Moreover, if Dave wants to access messages exchanged within the group during his period of inactivity, he can execute the procedure for obtaining secret keys described above for the first implementation. This then allows him to obtain the group secret keys that were the current group secret keys during his period of inactivity. Based on these secret keys, he can compute the group communication keys during this same period, and thus decipher the encrypted messages exchanged during this period.

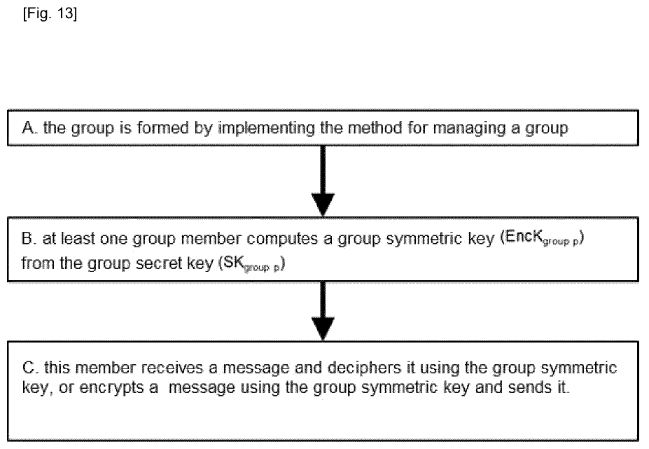

An exemplary implementation of the methods for managing a group according to the present disclosure is illustrated by FIG. 13.

This figure shows a method for encrypted communication within a group, comprising the following steps:
A. the group is formed by implementing one of the methods for managing a group described above.
B. at least one group member computes a group symmetric key from the group secret key.
C. this member then receives a message and deciphers it using the group symmetric key, or encrypts a message using the group symmetric key and sends it.

1. A method for managing a group comprising a plurality of members (U₁ . . . Uₙ), each member (Uᵢ) holding or being capable of holding a group secret key (SKj,k,p),
the method using an asymmetric cryptosystem (Enc,Dec) verifying the property, for two asymmetric key pairs (PK1,SK1) and (PK2,SK2):
Enc(PK1,SK2)=Enc(SK1, PK2), where Enc is the encryption function of the cryptosystem, and a registry wherein a smart contract is deployed;
a binary tree (A) being used to organize the group members;
each member being associated with a terminal node of the tree, this node being attached to a root node of the tree, directly or via a sequence of at least one node, the root node and when it exists said sequence of at least one node forming the attachment chain of the considered member;
each group member having an asymmetric key pair, of which the secret key and the public key are considered as the node secret key and the node public key for the terminal node associated with the member;
the public key of the root node being referred to as group public key;
the method comprising a procedure for adding a member to include a candidate seeking to join the group in the group, at a given time when
the group is formed by a set of members, referred to as pre-addition members, forming a pre-addition tree,
each pre-addition member has or is capable of computing a pre-addition node secret key for any node of their attachment chain; and
for each node of the pre-addition tree, a pre-addition node public key is registered in the registry;
the procedure for adding a member comprising the following operations:
S10) a request for entry of the candidate (Uₙ₊₁) into the group is sent to the smart contract, the request for entry comprising an authenticator (acc_{User}) and a personal public key (PKUn+1) of the candidate, the candidate further holding a personal private key (SKUn+1) from which their personal public key (PKUn+1) has been computed by means of the cryptosystem;
S20) the smart contract registers in the registry the entry into the group of a new member having the candidate's authenticator (acc_{Un+1}) and the candidate's public key (PKUn+1);
S30) the candidate determines or obtains from the smart contract a list of the node(s) of their attachment chain in the tree;
S40) in a neighbor-to-neighbor manner, for each node of their attachment chain, from the node of the tree to which they are directly attached to the root node (N1), the candidate computes the node secret key (SKj+1,k1,n+1) followed by the node public key (PKj+1,k1,n+1);
S50) the candidate publishes in the registry the node public key(s) (PKj,k,n) computed in step S40;
S60) the smart contract sends a member addition message at least to each active pre-addition group member; and
S70) on receipt of the member addition message, in a neighbor-to-neighbor manner, for each node of their attachment chain that is also part of the candidate's attachment chain, in the direction from the node of the tree to which they are directly attached to the root node, each active pre-addition member computes the node secret key (SKj+1,k1,n+1);
the node secret key (NPKj,k,p+1) of a given node being computed by a party whose attachment chain contains a first child of the given node:
if said given node has a second child and said party has access to a non-compromised public key of the second child, according to the secret key (SKj,k2−1,n) of the first active child and the public key (PKj,k2,n) of said second child of said given node; or in any other case,
according to the secret key (SKj−1,k1,p) of the first child of said given node.

2. The method for managing a group according to claim 1, the method further comprising a procedure for removing a member from the group, referred to as departing member (Up), other than the member who last joined the group, to remove the departing member from the group, said procedure for removing a member comprising:
S100) a request to remove the departing member is sent to the smart contract;
S110) the smart contract sends a key update message at least to each remaining active group member, indicating as key(s) to be refreshed and as compromised key the secret key of each of said node(s) of the attachment chain of the departing member;
S120) each remaining active member, referred to as considered remaining member, evaluates the node, referred to as first common node, which is the node of their attachment chain (CR2) furthest from the root node and which also belongs to the key chain to be refreshed;
S120-1) if the public key of the first common node has been refreshed since the key update message, in a neighbor-to-neighbor manner, the considered remaining member computes the secret key and the public node key of the considered node, from the first common node to the root node; conversely,
S120-2) if the public key of the first common node has not been refreshed since the key update message:
S120-22) for each node, referred to as node to be updated, located on the attachment chain from the first common node to the root node, the considered remaining member computes the secret key and the public node key of the node to be updated, and publishes the latter in the registry, said node to be updated then being referred to as updated node; any node for which the public key is compromised being considered as non-existent during any node secret computation;
S120-24) the smart contract sends a node update message at least to each other active group member, i.e. at least to each active group member, other than the departing member and the considered remaining member, indicating the updated node;
S120-26) in a neighbor-to-neighbor manner, each other member computes the node secret of the considered node, for each updated node also belonging to their attachment chain, in the direction from the terminal node of the tree to which they are attached to the root node.

3. The method for managing a group according to claim 2, further comprising a method for reconnecting a group member after removing a departing member, wherein:
S200) when a group member, referred to as reconnecting member, activates their connection to the group after a period of inactivity, the reconnecting member consults the messages received from the smart contract;
S210) when the reconnecting member has received a member removal message from the smart contract, the reconnecting member evaluates the node, referred to as first common node, which is the node of their attachment chain furthest from the root node and which also belongs to the key chain to be refreshed:
S210-1) if the public key of the evaluated node has been refreshed since the key update message, in a neighbor-to-neighbor manner, the reconnecting member computes the secret key and the public node key of the considered node, from the first common node to the root node; or conversely,
S210-2) if the public key of the evaluated node has not been refreshed since the member removal message:
S210-22) for each node, referred to as node to be updated, located on the attachment chain from the first common node to the root node, the reconnecting member computes the secret key and the public node key of the node to be updated and publishes the latter in the registry, said node to be updated then being referred to as updated node; any node for which the public key is compromised being considered as non-existent during any node secret computation;
S210-24) the smart contract sends a node update message at least to each other active group member, i.e. each active group member, other than the departing member and the reconnecting member, indicating the updated node;
S210-26) in a neighbor-to-neighbor manner, each other member computes the node secret of the considered node, for each updated node also belonging to their attachment chain, in the direction from the terminal node of the tree to which they are directly attached to the root node.

4. The management method according to claim 1, wherein at least one node secret key (NPKj,k,p+1) of a given node (Nj,k) is computed:
by computing a cryptographic element referred to as node shared secret (NPKj,k,p) according to the secret key (SKj,k2−1,n) of a first child and the public key (PKj,k2,n) of a second child of the given node; and
by computing the secret key (SKj,k,p+1) of the given node from said node shared secret (NPKj,k,p), for example as being equal to a part of the node secret.

5. A method for managing a group comprising a plurality of members, each member holding or being capable of holding a group secret key,
the method using an asymmetric cryptosystem (Enc, Dec) verifying the property, for two asymmetric key pairs (PK1,SK1) and (PK2,SK2):
Enc(PK1, SK2)=Enc(SK1,PK2), where Enc is the encryption function of the cryptosystem, and a registry (B) wherein a smart contract (SC) is deployed;
a list (Ln) being used to organize the group members;
the method comprising a procedure for adding a member to include a candidate seeking to join the group in the group,
at a given time when
the group is formed by a set of members, referred to as pre-addition members,
each pre-addition member has or is capable of computing a pre-addition secret key (SKgroup n) of the pre-addition group; and
a pre-addition public key (PKgroup n) of the pre-addition group is registered in the registry;
wherein the procedure for adding a member comprises the following operations:
S310) a request for entry of the candidate (Uₙ₊₁) into the group is sent to the smart contract, the request for entry comprising an authenticator (accuser) and a personal public key (PKUn+1) of the candidate, the candidate further holding a personal private key (SKUn+1) from which their personal public key (PKUn+1) has been computed by means of the cryptosystem;
S320) the smart contract registers in the registry the entry into the group of a new group member having the candidate's authenticator (acc_{Un+1}) and the candidate's public key (PKUn+1);
S330) based on the pre-addition public key (PKgroup n) of the pre-addition group and their personal private key (SKUn+1), the candidate computes a new group secret key (SKgroup n+1) followed by a new group public key (PKgroup n+1) for the group;
S340) the candidate publishes in the registry the new public key value of the group (PKgroup n+1) computed in step S330;
S350) the smart contract sends a group key update message at least to each active pre-addition group member; and
S360) on receipt of the group key update message, based on the pre-addition secret key (SKgroup n) of the pre-addition group and the candidate's personal public key (PKUn+1), each active pre-addition member computes the new group secret key (SKgroup n+1).

6. The method for managing a group according to claim 5, wherein:
no later than some time after a reconnection of a group member who has been inactive, or at the request of the latter during their reconnection, when the procedure for adding a member has been executed, the smart contract sends a group key update message after adding a member to said member who has been inactive; and
the method for managing a group further comprises a method for reconnecting said member who has been inactive after adding a member, wherein:
S400) when said member who has been inactive reconnects to the group, they consult the messages received from the smart contract;
S410) when the reconnecting member has received a group key update message from the smart contract after addition of a member, based on the pre-addition secret key (SKgroup n) of the pre-addition group and the candidate's personal public key (PKUn+1), said member who has been inactive computes the new group secret key (SKgroup n+1).

7. The method for managing a group according to claim 5, the method further comprising a procedure for removing a member from the group, referred to as departing member (Up), other than the member who last joined the group, to remove the departing member from the group, said procedure for removing a member comprising:
S500) a request to remove the departing member is sent to the smart contract;
S510) the smart contract identifies a member (Uini), referred to as initialization member, who is an active group member who joined the group before the departing member;
S520) the smart contract sends a new group addition message to each active group member who joined the group after the initialization member, referred to as member to be reintegrated, with the exception of the departing member, inviting the latter to rejoin the group;
S530) on receipt of the new group addition message, for each member to be reintegrated (Up), steps S330 to S360 of the procedure for adding a member are performed, considering the member to be reintegrated as the candidate.

8. The method for managing a group according to claim 5, wherein at least one new group secret key (SK_{group p+1}) is computed:
by computing a cryptographic element referred to as group shared secret (NPK_{group p}) according to the secret key of a group member and a group public key (PK_{group p}), or according to the public key (PKi,p) of a group member and a group secret key (SK_{group p}); and
by computing the new group secret key (SKj,k,p+1) from said group shared secret (NPK_{group p}), for example as being equal to a part of the group shared secret.

9. The method for managing a group according to claim 1, wherein:
when a new public group key is registered in the registry, the smart contract assigns a ‘Blind’ status to all remaining members other than the member, referred to as group update member, who triggered this registration;
when a member other than the triggering member computes the group secret key, they inform the smart contract; on this basis, the smart contract assigns an ‘Online’ status to said other member; and
the method includes at least one procedure implemented using the smart contract, other than a procedure for adding or removing a member, wherein at least one action of the smart contract is carried out according to the member status.

10. The method for managing a group according to claim 1, further including a procedure for a reconnecting member following a period of inactivity retroactively obtaining at least one group secret key to be obtained, which had been a current group key during said period of inactivity, said retroactive obtaining procedure including the following steps:
S600) based on information published in the registry and/or by querying the smart contract, the reconnecting member determines an authenticator of a key holder member from whom they can obtain said at least one secret key to be obtained;
S610) the reconnecting member requests the key holder member to provide said member with at least one secret key to be obtained;
S620) the key holder member verifies that the reconnecting member was a group member at a time when said at least one requested secret key was the current group secret key, and that the reconnecting member still belongs to the group.
S630) if the result of the verification is positive, the considered key holder member opens a secure auxiliary communication channel with the reconnecting member, for example by following the protocol indicated by French patent application no. 1763394; and
S640) via the secured auxiliary communication channel thus opened, the considered key holder member provides said reconnecting member with at least one requested secret key to be obtained.

11. The method for managing a group according to claim 1, further comprising a step (S80; S370), wherein at least one active group member computes a group symmetric key from a group secret key.

12. The method for managing a group according to claim 11, wherein to compute said group symmetric key, said at least one active group member:
computes a cryptographic element referred to as group shared secret (NPK_{group p}) according to their secret key (SKi,p) and a group public key (PK_{group p}), or according to the public key (PKi,p) of a group member and a group secret key (SK_{group p}); and
computes the group symmetric key (EncK_{group p+1}) from said group shared secret (NPK_{group p}), for example as being equal to a part of the group secret.

13. A method for encrypted communication within a group, comprising the following steps:
A. the group is formed by implementing the method for managing a group according to claim 1;
B. at least one group member computes a group symmetric key (EncK_{group p}) from the group secret key (SK_{group p}); and
C. this member receives a message and deciphers it using the group symmetric key, or encrypts a message using the group symmetric key and sends it.

14. A method for encrypted communication within a group, comprising the following steps:
A. the group is formed by implementing the method for managing a group according to claim 5;
B. at least one group member computes a group symmetric key (EncK_{group p}) from the group secret key (SK_{group p}); and
C. this member receives a message and deciphers it using the group symmetric key, or encrypts a message using the group symmetric key and sends it.

15. The method for managing a group according to claim 5, wherein:
when a new public group key is registered in the registry, the smart contract assigns a ‘Blind’ status to all remaining members other than the member, referred to as group update member, who triggered this registration;
when a member other than the triggering member computes the group secret key, they inform the smart contract; on this basis, the smart contract assigns an ‘Online’ status to said other member; and
the method includes at least one procedure implemented using the smart contract, other than a procedure for adding or removing a member, wherein at least one action of the smart contract is carried out according to the member status.

16. The method for managing a group according to claim 5, further including a procedure for a reconnecting member following a period of inactivity retroactively obtaining at least one group secret key to be obtained, which had been a current group key during said period of inactivity, said retroactive obtaining procedure including the following steps:
S600) based on information published in the registry and/or by querying the smart contract, the reconnecting member determines an authenticator of a key holder member from whom they can obtain said at least one secret key to be obtained;
S610) the reconnecting member requests the key holder member to provide said member with at least one secret key to be obtained;
S620) the key holder member verifies that the reconnecting member was a group member at a time when said at least one requested secret key was the current group secret key, and that the reconnecting member still belongs to the group.
S630) if the result of the verification is positive, the considered key holder member opens a secure auxiliary communication channel with the reconnecting member, for example by following the protocol indicated by French patent application no. 1763394; and
S640) via the secured auxiliary communication channel thus opened, the considered key holder member provides said reconnecting member with at least one requested secret key to be obtained.

17. The method for managing a group according to claim 5, further comprising a step (S80; S370), wherein at least one active group member computes a group symmetric key from a group secret key.

18. The method for managing a group according to claim 17, wherein to compute said group symmetric key, said at least one active group member:
computes a cryptographic element referred to as group shared secret (NPK_{group p}) according to their secret key (SKi,p) and a group public key (PK_{group p}), or according to the public key (PKi,p) of a group member and a group secret key (SKgroup p); and
computes the group symmetric key (EncK_{group p+1}) from said group shared secret (NPK_{group p}), for example as being equal to a part of the group secret.
